(19) United States
(12) Patent Application Publication
(10) Pub. No.: US 2012/0285153 A1
(43) Pub. Date: Nov. 15, 2012

(54) Drive System for Electric Vehicles

(75) Inventor: Christopher Christiansen, Parkland, FL (US)

(73) Assignee: Victory Truck & Bus Company, Inc., Boca Raton, FL (US)

(21) Appl. No.: 13/468,216

(22) Filed: May 10, 2012

Related U.S. Application Data
(60) Provisional application No. 61/485,038, filed on May 11, 2011.

(51) Int. Cl. F16D 31/02; F04B 35/04; B67D 7/70

(52) U.S. Cl. 60/327; 137/565.29; 417/410.1; 60/486

(57) ABSTRACT

A system includes a high pressure accumulator; a low pressure reservoir; and a plurality of pumps configured to control the flow of fluid between the high pressure accumulator and the low pressure reservoir, a battery; an electric motor powered by the battery; a management unit in communication with the electric motor and the plurality of pumps.

This application claims benefit of US Provisional Application No 61/485,038 filed May 11, 2011, which is incorporated herein by reference in its entirety for all purposes.

### DRIVE SYSTEM FOR ELECTRIC VEHICLES

### Background

The present disclosure is directed to electric vehicle technology and more specifically to a vehicle drive system for electric power.

In order to reduce fuel consumption and vehicle emissions, some vehicles utilize a hybrid drive system that uses a second source of energy such as electricity. Hybrid electric vehicles obtain the electric energy needed by capturing the mechanical energy produced from using fuel, and converting that mechanical energy to electrical energy that is stored in an storage equipment for later use.

This mode of energy conversion is not efficient, since converting mechanical energy to electrical energy leads to losses. Generally, maintaining energy in its native form for later use results in a more efficient system. In addition, regenerative breaking reduces the life of the battery due to energy spikes that occur during the process.

Furthermore, energy storage equipment is able to store only a minimal portion of the converted captured energy from vehicle braking as a majority is lost due to friction and heat.

Embodiments of the invention address these and other problems individually and collectively.

### BRIEF SUMMARY

In accordance with one embodiment of the invention, a system includes a high pressure accumulator, a low pressure reservoir, and a plurality of pumps configured to control the flow of fluid between the high pressure accumulator and the low pressure reservoir

In another embodiment, the system further includes a battery, an electric motor powered by the battery, and a management unit in communication with the electric motor and the plurality of pumps. The management unit is configured to detect when pressure of the high pressure accumulator drops below a certain level and operates the electric motor to power the plurality of pumps.

In still another embodiment, a method includes the steps of accumulating fluid pressure in a high pressure accumulator, and rotating a drive shaft using the fluid pressure. The fluid pressure is then directed to rotate the drive shaft using one or more pumps.

In yet another embodiment, a method includes detecting when a brake system of a vehicle is engaged. Thereafter, using a check value, redirecting fluid from a low pressure reservoir to a high pressure accumulator. The energy produced from engaging the brake system of the vehicle is used to transfer fluid from the low pressure reservoir to the high pressure accumulator.

The following detailed description and the accompanying drawings provide a better understanding of the nature and advantages of the present invention.

### BRIEF DESCRIPTION OF THE DRAWINGS

FIG. 1 is a schematic of the system components, according to an embodiment of the invention.

FIG. 2 is an illustration of the system while in drive mode, according to an embodiment of the invention.

FIG. 3 is an illustration of the system while in brake mode, according to an embodiment of the invention.

FIG. 4 is a schematic of a bladder type accumulator, according to an embodiment of the invention.

FIG. 5 illustrates an example a bent axis hydraulic pump motor, according to an embodiment of the invention.

FIG. 6 illustrates an example of a low pressure reservoir, according to an embodiment of the invention.

FIG. 7 is a flowchart of energy utilization in motor mode, according to an embodiment of the invention.

FIG. 8 is a flowchart of energy recapturing in regeneration mode, according to an embodiment of the invention.

### DETAILED DESCRIPTION

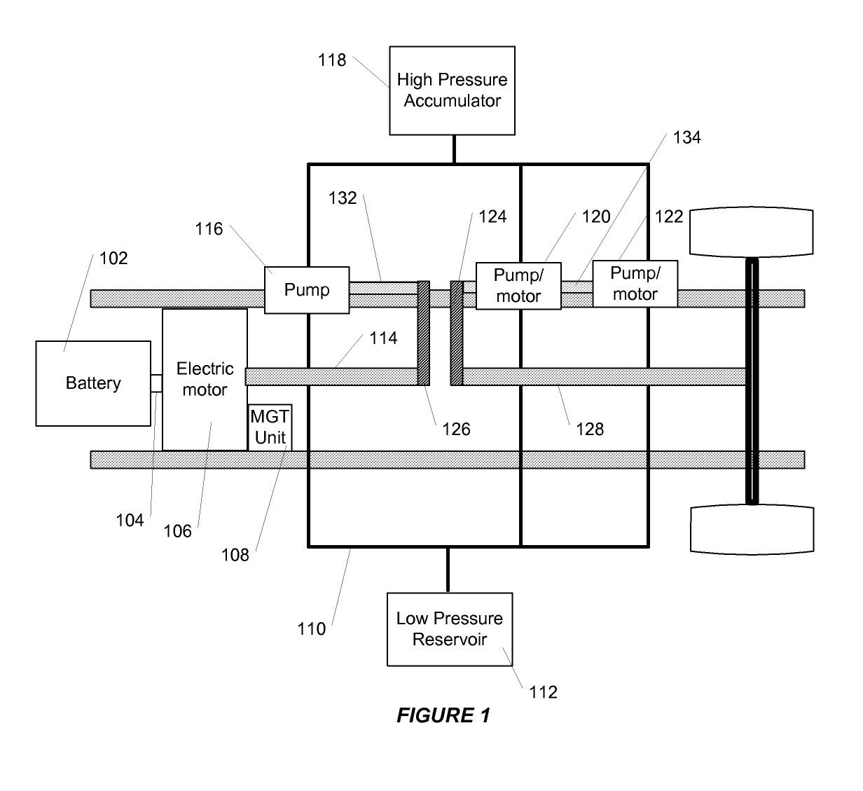

FIG. 1 illustrates the components of an electric hydraulic drive train utilizing a hydraulic drive train for propulsion and kinetic energy recapturing. The vehicle may be all-fluid driven utilizing an arrangement of electric motor, batteries, hydraulic pump/motors, gears and accumulators to operate. Battery 102 may be any type of organic or inorganic rechargeable battery including lithium-ion, lead-acid, Nickel Metal Hydride, Sodium and lithium metal. The system's electric motor 106 may be any type of electric motor, including alternating current (AC) or direct current (DC). The electric motor 106 may be connected to the battery pack 102 through the power interface 104.

The system may include a high pressure accumulator 118 and a low pressure reservoir 112. In one embodiment, the high pressure accumulator 118 may be a gas-type accumulator that utilizes nitrogen. However, other types of accumulators such as a spring accumulator and metal bellows accumulator may also be utilized. Design of the high pressure accumulator 118 may be bladder type or piston type. Low pressure reservoir 112 may be an accumulator or a low pressure hydraulic tank. Low pressure reservoir 112 will be discussed in detail later.

The system may be compromised of two hydraulic pump motors 120 and 122, and a single hydraulic pump 116. The system illustrated in FIG. 1 is utilizing a primary pump, however, the system may also function utilizing a primary pump/motor although at lower efficiency. The system may operate in two primary modes: drive mode and brake mode. Both modes will be described in detail below. Further, the system may be comprised of an output shaft 114 connected to a primary gear 126 through gear shaft 132. The electric motor 106 may be connected to hydraulic pump 116. Hydraulic pump 116 may pressurize fluid to the high pressure accumulator 118 or generate enough fluid pressure to run the vehicle directly through pump motors 120 and 122. The purpose for two identical pumps will be described later in detail. Pump motors 120 and 122 may be connected to a secondary gear 124 through gear shaft 134. Secondary gear 124 may drive the driveshaft 128 to initiate propulsion through rear axle differential.

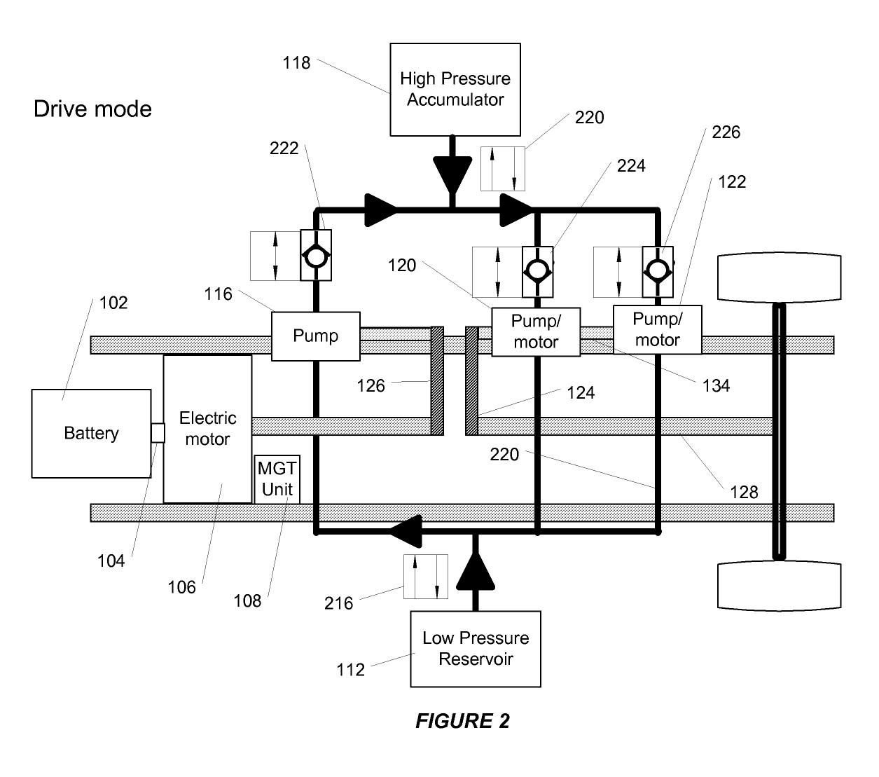

In one embodiment, the system operates in two modes: drive mode and brake mode. FIG. 2 illustrates the system flow in drive mode. Each pump 116 and pump motors 120 and 122 may have a check valve 222, 224 and 226 respectively, controlling fluid flow. When initiating acceleration, the management unit 108, may evaluate whether the high pressure accumulator 118 has enough stored pressure for the vehicle to begin acceleration. In primary launch mode, the pressure in the accumulator 118 may be sufficient for the management unit 108 to initiate fluid flow from the accumulator 118 to secondary pumps 120 and 122. Secondary pumps 120 and 122 may rotate the driveshaft 128 through the secondary gear 124. Secondary drive mode occurs when fluid pressure within the accumulator 118 becomes low. At this point, the management unit 108 may initiate the electric motor 106 to rotate the primary pump 116 in order to generate fluid pressure in the system. Pressurized fluid may flow to secondary pumps 120 and 122 to drive rotation through secondary gear 124. For applications requiring a longer duty cycle, the system may utilize an internal combustion engine (not illustrated) powering a generator that charges the batteries. In one embodiment, the generator may not impact the operation of the system, but purely charge the batteries directly.

Contrary to traditional hydraulic drive trains, in an embodiment of the invention, this system is specifically designed for electric propulsion. The system management 108 unit may be configured to operate with other operational variables as the arrangement of the system components enables new operational methods. Traditionally, a diesel engine has to have a minimum torque rise time of four seconds or more in order to achieve the desired torque. Additionally, continuous on/off functions of an internal combustion engine severely increases wear and tear. It can be appreciated that due to the unique abilities of electric propulsion, the system may have unlimited on/off scenarios with zero lag times and immediate maximum torque which reduces energy consumption and increases efficiency. Also, the primary pump may not require a motor function as an electric motor does not require external startup assistance.

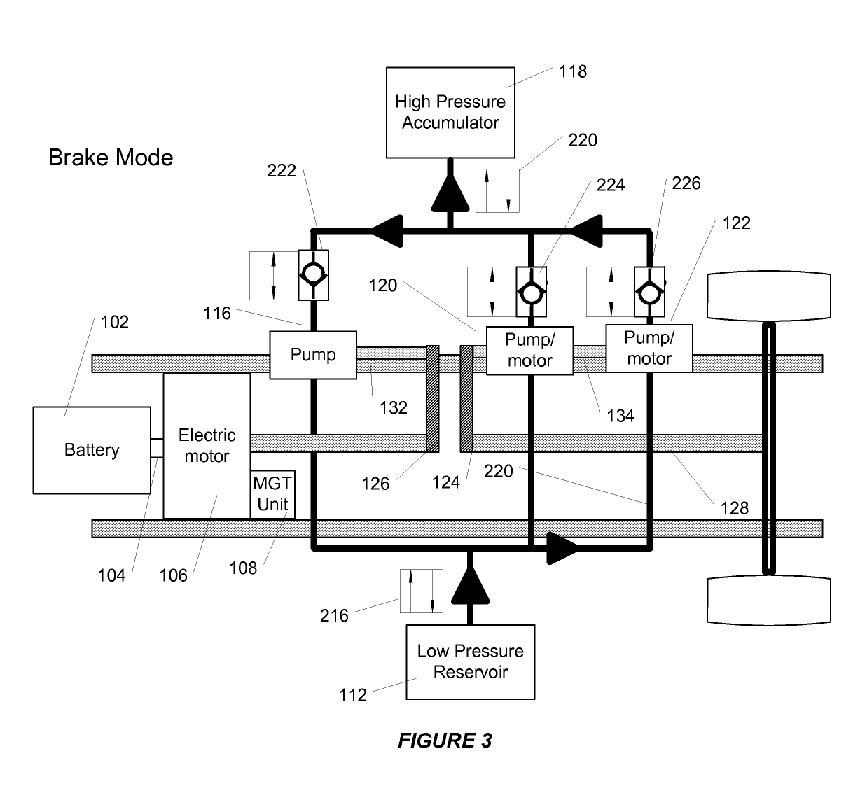

FIG. 3 illustrates the second system mode: brake mode. In brake mode, the primary pump 116 may be disabled by the management unit 108. The primary check valves 222, 224, and 226 may be set in opposite direction from drive mode allowing fluid to flow from secondary pumps/motor 122 and 120 to high pressure accumulator 118. During braking, the secondary pumps 120 and 122 may switch to motor mode adding resistance to the driveshaft which will slow down the vehicle while utilizing rotational energy for the secondary motors 120 and 122 to generate fluid pressure.

The reason for using two identical secondary pumps, according to one embodiment of the invention, may be to maximize fluid flow while secondary pumps may be in motor mode. The energy recapturing may be limited by fluid flow if system utilizes only one pump. The pressurized fluid may be stored in the accumulator 118. As a result, the vehicle may slow down while recuperating otherwise lost energy in the form of stored fluid in the high pressure accumulator 118. When pressure within the accumulator 118 reaches full capacity, fluid may continue to flow through the system. In order to come to a complete stop, the vehicle may have a traditional braking system. The hydraulic system's function may be to recapture otherwise lost energy. In one embodiment, the hydraulic system may not act as the primary braking function.

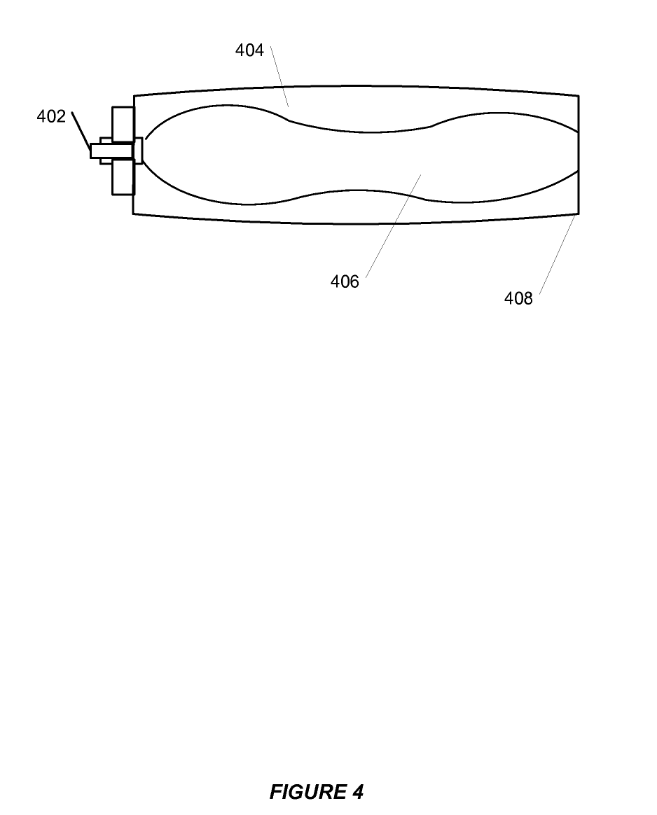

FIG. 4 illustrates a high pressure accumulator according to one embodiment of the invention. In this embodiment, a bladder accumulator is illustrated but the system may function with any accumulator capable of holding enough pressure depending on the weight of the vehicle. In one example, the accumulator may hold 2000 psi pressure. For a medium to heavy duty system an accumulator with above 5000 psi operational rating with a 25000 psi maximum level may be preferred. Accumulator bladder 406 may be rubber with steel valves and pressure assembly 402. In one embodiment, surrounding gas pressure may be nitrogen, and the accumulator case material 408 may be steel or composite materials. Fluid may flow through valve and pressure assembly 402 until maximum pressure may be achieved. When release of pressure may be desired, valve and pressure assembly 402 may open and the surrounding nitrogen gas 404 may aid in forcing the fluid flow out through the bladder 406.

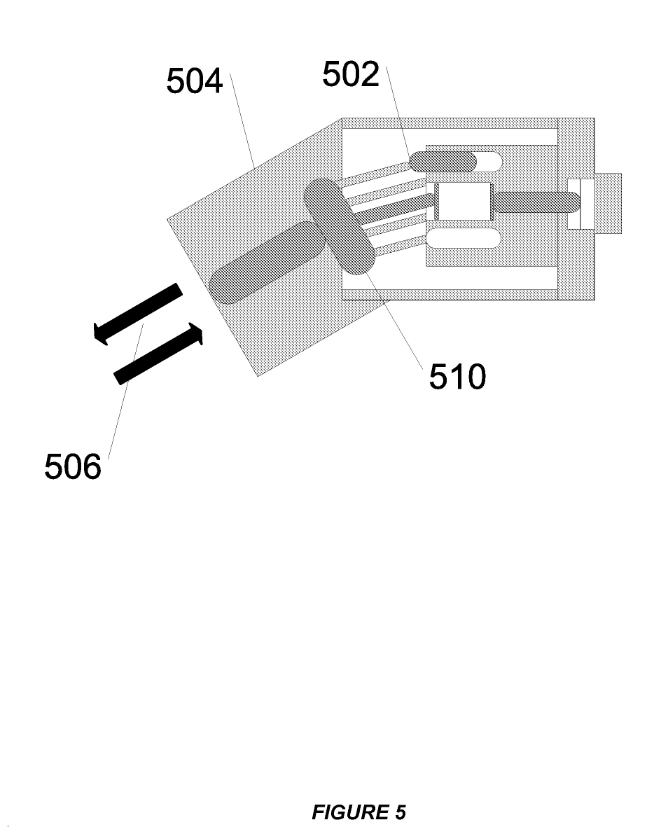

FIG. 5 illustrates a bent axis variable displacement pump. The system may utilize one or more variable or fixed displacement pumps. In one embodiment two bent axis variable pumps may be utilized in order for the system to generate enough fluid flow during energy recapturing. The system may function with only one pump, but at lower regeneration efficiency. The illustrated pump may have a steel, iron, aluminum or magnesium casing 504. System pistons 502 may drive the swash plate 510 which may increase or decrease pump volume displacement. Hydraulic fluid flow 506 may be either reversible depending on the pump's mode.

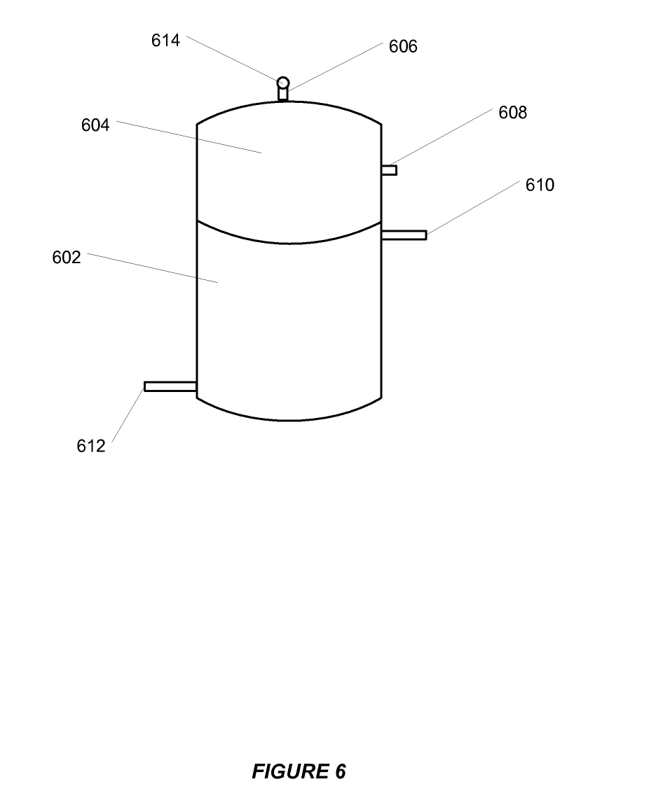

FIG. 6 illustrates a low pressure reservoir. In this embodiment, the low pressure reservoir may be a low pressure tank, however, the low pressure reservoir may function with a low pressure accumulator as well. The reservoir functions similar to an accumulator except that fluid pressure may be constant. The primary function of the reservoir may be to hold excessive fluid not needed by the system depending on system speed. In addition, the reservoir may provide for thermal expansions of the hydraulic fluid based upon variable operational temperatures. FIG. 6 illustrates a separated reservoir, but a non separated reservoir may also function. Pressurized gas 604 may be nitrogen, with tank pressure typically ranging from 50 to 200 psi. For weight savings, in one embodiment, a composite tank material 602 may be used. In another embodiment, the material used may also be steel. Check valve 614 may ensure that tank pressure remains constant. The illustrated low pressure tank may use a single access point to the system with multiple ports or a separated inlet 610 and outlet port 612. Pressure relief valve 608 may be used for safety in case of high pressure.

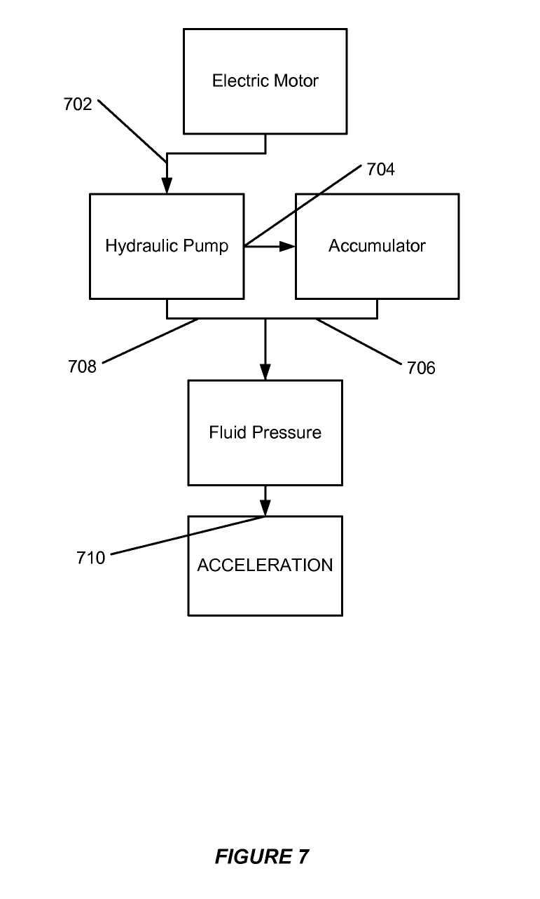

FIG. 7 illustrates the energy flow for the system in drive mode. If high pressure accumulator 704 has enough stored high pressure fluid, high pressure fluid may flow from accumulator 706 to secondary pumps in order to provide acceleration 710. If the accumulator 704 has low pressure, the hydraulic pump may drive fluid pressure to the accumulator 704 or directly to the secondary pumps to drive the vehicle 708.

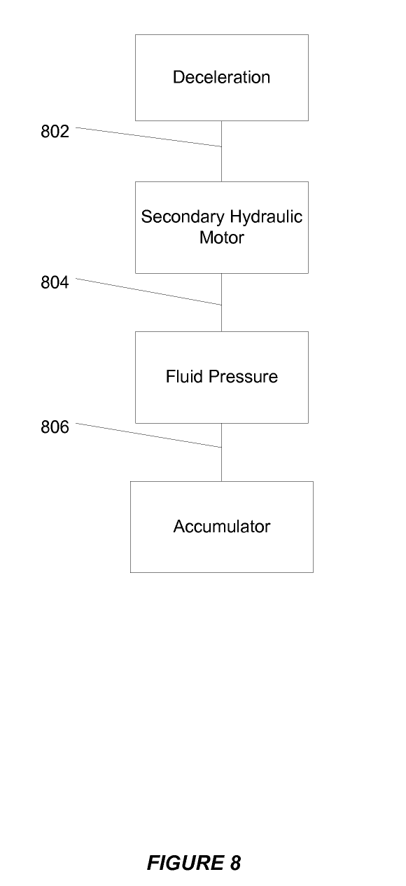

FIG. 8 outlines the energy flow during energy recapturing mode. When decelerating, the secondary hydraulic pump motors may switch to motor function 802. The motors may utilize the driveshaft's rotational force to pump fluid pressure 804 to the high pressure accumulator 806.

It can be appreciated that the embodiments of the invention provide many advantages. For example, the above-described system allows for unlimited on/off functions by utilizing the instant torque functionality of electric motors. This can advantageously be used to save several seconds per start and stop interval which makes a considerable amount of energy consumption difference over the life of the vehicle.

Some embodiments of the present invention, for example, functions of the management unit 108 can be implemented via control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, some of the entities described herein may be embodied by a computer or controlled by a computer that performs any or all of the functions and steps disclosed.

Any recitation of “a”, “an” or “the” is intended to mean “one or more” unless specifically indicated to the contrary.

What is claimed is:

1. A system comprising:
a high pressure accumulator;
a low pressure reservoir; and
a plurality of pumps configured to control the flow of fluid between the high pressure accumulator and the low pressure reservoir.

2. The system of claim 1, further comprising:
a battery;
an electric motor powered by the battery;
a management unit in communication with the electric motor and the plurality of pumps, wherein the management unit is configured to detect when pressure of the high pressure accumulator drops below a certain level and operate the electric motor to power the plurality of pumps.

3. The system of claim 1, wherein the plurality of pumps are configured to rotate a driveshaft.

4. A method comprising:
accumulating fluid pressure in a high pressure accumulator; and
rotating a drive shaft using the fluid pressure, wherein the fluid pressure is directed to rotate the drive shaft using one or more pumps.

5. The method of claim 4, further comprising:
storing the fluid in a low pressure reservoir after depressurization; and
transferring the fluid from the low pressure reservoir to the high pressure accumulator.

6. The method of claim 6, further comprising:
pressurizing the high pressure accumulator when pressure falls below a predetermined level.

7. The method of claim 6, wherein the high pressure accumulator is pressurized using a pump operated by an electric motor.

8. A method comprising:
detecting when a brake system of a vehicle is engaged;
using a check value, redirecting fluid from a low pressure reservoir to a high pressure accumulator, wherein the energy produced from engaging the brake system of the vehicle is used to transfer fluid from the low pressure reservoir to the high pressure accumulator.

9. The method of claim 8, wherein the fluid in the high pressure accumulator is used to rotate a drive shaft.

10. The system of claim 2, wherein the system allows for unlimited on/off functions by utilizing instant torque functionality of the electric motor.
